(19) United States
(12) Patent Application Publication
(10) Pub. No.: US 2005/0071461 A1
(43) Pub. Date: Mar. 31, 2005

(54) Proxy alerting

(75) Inventors: James T. Mihm, Gresham, OR (US); Bill R. Hannon, Beaverton, OR (US)

Correspondence Address: Schwegman, Lundberg,;Woessner & Kluth, P.A., P.O. Box 2938, Minneapolis, MN, 55402, US

(73) Assignee: Intel Corporation

(21) Appl. No.: 10/674,936

(22) Filed: Sep. 30, 2003

(51) Int. Cl. G06F 15/173

(52) U.S. Cl. 709/224; 340/531

(57) ABSTRACT

Systems and methods provide an alert proxy. A monitored system detects a condition causing an alert to be generated, and further detects that the alert cannot be sent through a first network interface configured for sending alert messages. The monitored system sends the alert message to a proxy system through a second network interface. The proxy system then forwards the alert message to a management system configured to receive alert messages on the first network.

### FIELD

The present invention relates generally to network devices, and more particularly to proxy alerting in network devices.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2003, Intel Corporation. All Rights Reserved.

### BACKGROUND

Many modern computer systems have the capability to monitor the status of components within the system to detect actual or impending failure of the component. When such a failure is detected, the system sends an alert to a management system. For example the system may monitor the health of an interface card for a hard drive coupled to the system to determine whether or not the interface card is operating properly. If the interface card fails, the system sends an alert to the management system. The management system can then arrange for the replacement of the failing interface card.

Typically the alert is sent through a communications interface that communicatively couples the monitored system to the management system. Examples of such communications interfaces include network interfaces and modem interfaces. However, if the failure is in a component that supports the communications interface of the monitored system, then the monitored system will not be able to send the alert through the network to the management system. As a result, there is a need in the art for the present invention.

### BRIEF DESCRIPTION OF THE DRAWINGS

FIG. 1 is a block diagram illustrating an overview of a system incorporating embodiments of the invention.

FIG. 2 is a block diagram providing further system level details of an individual device incorporating embodiments of the invention.

FIG. 3 is a flowchart illustrating a method for sending an alert to a proxy system according to an embodiment of the invention.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the various embodiments of the invention, and it is to be understood that other embodiments may be utilized and that logical, mechanical, electrical and other changes may be made without departing from the scope of the present invention. The following detailed description is, therefore, not to be taken in a limiting sense.

In the Figures, the same reference number is used throughout to refer to an identical component which appears in multiple Figures. Signals and connections may be referred to by the same reference number or label, and the actual meaning will be clear from its use in the context of the description. Further, the same base reference number (e.g. 120) is used in the specification and figures when generically referring to the actions or characteristics of a group of identical components. A numeric index introduced by a decimal point (e.g. 120.1) is used when a specific component among the group of identical components performs an action or has a characteristic.

The detailed description is divided into multiple sections. In the first section the hardware and software operating environment of different embodiments of the invention are described. In the second section methods according to various embodiments of the invention are described.

### Operating Environment

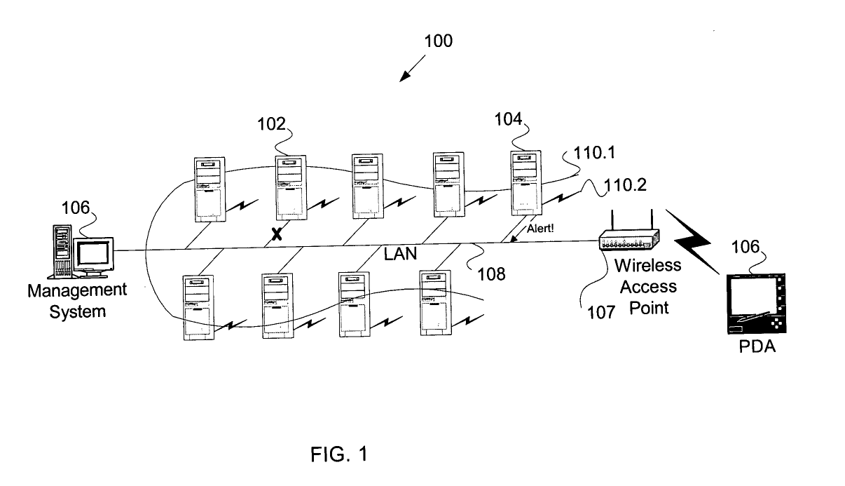

FIG. 1 is a block diagram of the major components of a hardware and software operating environment 100 incorporating various embodiments of the invention. The systems and methods of the various embodiments of the invention may be incorporated on any hardware or software system that can support multiple communications interfaces. Generally such hardware includes personal computers, server computers, mainframe computers, laptop computers, portable handheld computers, personal digital assistants (PDAs), network enabled cellular telephones, wireless base stations, routers, switches, network interface cards, baseboard management controllers and hybrids of the aforementioned devices. In some embodiments of the invention, operating environment 100 comprises a network having at least one monitored system 102, at least one proxy system 104 and a management system 106, all communicably coupled via a first network 108. In addition, monitored system 102 and proxy system 104 are communicably coupled via a second network 110.

The software components running in the operating environment may be read from a machine-readable media and run under the control of an operating system, and interfaced with the operating system. Examples of such machine-readable media include hard disks, floppy disks, CD-ROMs, DVD-ROMs. Further, machine-readable media includes wired and wireless signals transmitted over a network. Examples of operating systems include Windows® 95, Windows 98®, Windows Me®, Windows CE®, Windows® NT, Windows 2000®, and Windows XP® by Microsoft Corporation. However, the embodiments of the invention are not limited to any particular operating system, and in alternative embodiments the software components may operate within the Palm OS® from Palm Inc., variants of the UNIX and Linux operating systems and cellular telephone operating systems.

Additionally, in varying embodiments the systems and methods of the present invention may be implemented in firmware.

Monitored system 102 comprises any type of system that is capable of monitoring internal components and detection failure or such components. As noted above, monitored system 102 can be a server system, a personal computer, a laptop computer, a PDA, switch, router, a computer interface card, a baseboard station, a blade within a collection of blades etc. The embodiments of the invention are not limited to any particular type of system. Monitored system 102 may be communicably coupled to a first network 108, such as a LAN (Local Area Network). In addition, monitored system 102 may be coupled to a second network 110. Second network 110 may be a wireless network 110.2 that operates using IEEE 802.11 protocols or Bluetooth protocols. Further details regarding the IEEE 802.11 protocols may be found in “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999.” Further details on the Bluetooth protocol may be found in “Bluetooth System Specification, Bluetooth Special Interest Group, Ver. 1.1, March 2001”.

Additionally, second network 110 may be a wired network 110.1 that conforms to a wired network protocol. In some embodiments of the invention, wired network 110.1 comprises a chassis management bus, for example the Intelligent Chassis Management Bus (ICMB) from Intel Corp. Furthermore, wired network 110.1 may be the Infiniband® network from Intel Corp.

Proxy system 104 may be any of the same types of systems as monitored system 102. Like monitored system 102, proxy system 104 may be communicably coupled to two or more networks, a first network 108 and a second network 110.

Management system 106 may be a system that is configured to receive alert messages from systems that monitor and report component failures such as monitored system 102. Management system 106 may be a server computer, a personal computer, a laptop computer, or a handheld computer such as a PDA (Personal Digital Assistant). In some embodiments, management system 106 is communicably coupled to first network 108 and receives alert messages over network 108. Management system 106 may also receive alert messages via a wireless network 110.2 or through a wireless access point 107 communicably coupled to first network 108. Alert messages typically have a predefined structure and command set used to provide alert data regarding the reason for the alert and the component generating the alert. In some embodiments, the alert messages and interfaces conform to the Intelligent Platform Management Interface (IPMI) as defined in “Intelligent Platform Management Interface Specification”, version 1.5 published Feb. 20, 2002 and draft version 2.0 published Sep. 15, 2003.

In general, the embodiments of the invention operate as follows. Monitored system 102 detects a failure of a component and is configured to report the alert to management system 106 over network 108. Monitored system 102 also detects that it is unable to use network 108 to report the alert. There may be various reasons why monitored system 102 cannot user network 108 to report the alert. Examples include unplugged cables connecting system 102 to network 108 and failure of communications interface cards such as network interface cards or modem interface cards.

Upon detecting that it will be unable to send an alert via the normal channel of network 108, monitored system 102 sends the alert message to proxy system 104 via a second communications channel 110. Proxy system 104 receives the alert message and forwards it to management system 106 on behalf of monitored system 102. In this way, management system receives alerts that it would otherwise not receive from monitored system 102. Further details on the operation of embodiments of the invention are provided below.

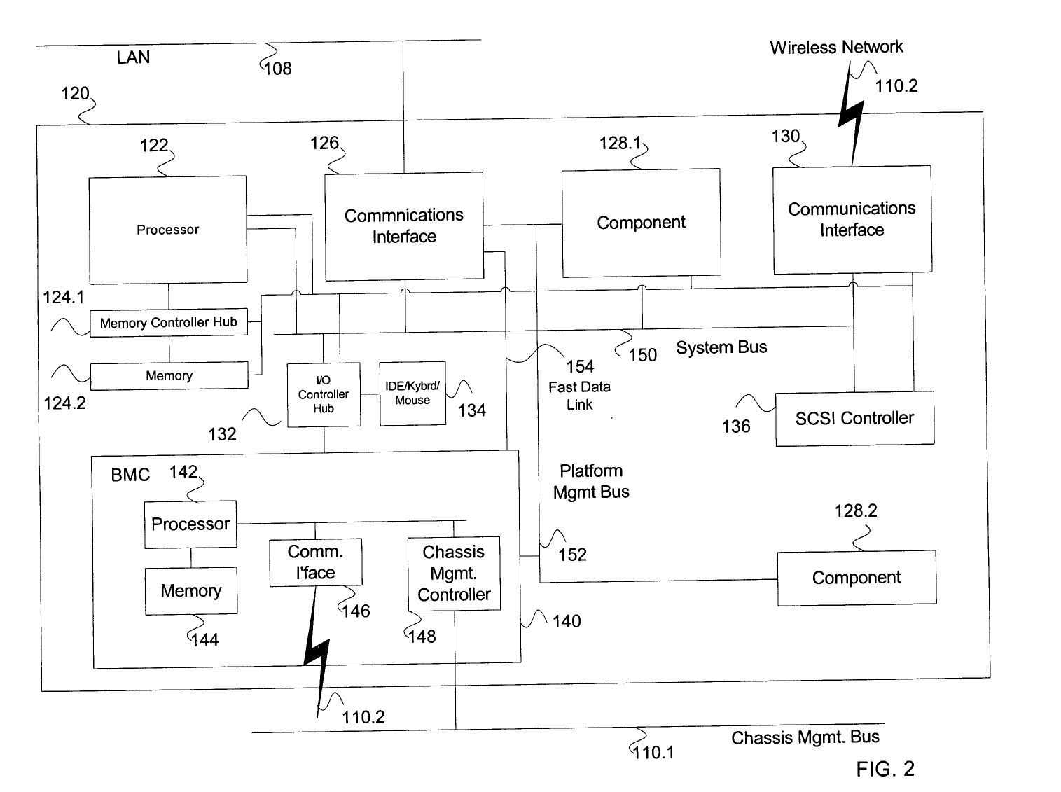

FIG. 2 is a block diagram providing further system level details of a baseboard device 120 incorporating embodiments of the invention. In some embodiments of the invention, baseboard device 120 comprises a processor 122, memory controller hub 125, memory 124, I/O controller hub 132, IDE/Keyboard/Mouse interfaces 134, first communications interface 126, components 128, second communications interface 130 and SCSI controller 136, all coupled via system bus 150. While illustrated in FIG. 2, not all embodiments of the invention need include all of the items listed, and various embodiments of the invention may include varying combinations of the above-listed items.

In some embodiments, the baseboard management controller (BMC) 140 may be attached to an I/O controller hub 132. In alternative embodiments, BMC 140 may be embedded within an I/O controller chipset on baseboard device 120.

Processor 122 may be any type of processor, including general purpose processors such as the Intel Pentium and Itanium line of processors from Intel Corporation, and special purpose processors such as network processors. Memory 124 may be any type of memory, including RAM, ROM, or any other device capable of storing computer instructions and/or data.

The IDE 134 and SCSI 136 devices may be any type of storage devices including hard-drives, CD-ROM, DVD-ROM, or any other device capable of storing computer instructions and/or data.

First communications interface 126 may be any type of interface capable of communicably coupling baseboard system 120 to one or more external systems. In some embodiments of the invention, first communications interface 126 is a network interface capable of coupling baseboard system 120 to a network such as LAN 108. In alternative embodiments of the invention, first communications interface 126 may be a modem. In further alternative embodiments, first communications interface 126 may be an Infiniband host card adapter capable of coupling baseboard system 120 to an Infiniband network.

Components 128 may be any type of internal component supported on baseboard system 120. The components may be coupled to the processor 122 via system bus 150, or they may be independent of processor 122 and bus 150. Examples include interface cards such as serial I/O interfaces, parallel I/O interfaces, Firewire interfaces, USB interfaces, hard-drive interfaces, removable media interfaces etc. Examples of components that may not be connected via bus 150 include fans and temperature sensors (not shown).

Second communications interface 130 may be a network interface providing wired or wireless communications to second network 110.2. As noted above, second network 110.2 may be a wireless network supporting an IEEE 802.11 or a Bluetooth interface. Additionally, in alternative embodiments, second network interface may be an interface to a chassis management bus such as ICMB.

BMC 140 comprises a board management controller designed to monitor the status of various components on baseboard system 120 such as components 128, and interfaces 126 and 130. In some embodiments of the invention BMC 140 includes a BMC processor 142, BMC memory 144, communications interface 146 and chassis management controller 148. BMC processor 140 may be any type of processor capable of executing instructions allow BMC to monitor status of the various components of baseboard system 120. BMC memory 144 may be any type of memory capable of storing instructions to be executed by BMC processor 142.

In some embodiments, BMC 140 includes an onboard communications interface 146. In some embodiments, onboard communications interface 146 may be a network interface card, a hardware chip or chipset, or any other hardware designed to send and receive wired or wireless transmissions of data that conform to a wired or wireless protocol. In some embodiments of the invention, the wireless protocol may be any of the IEEE 802.11 family of protocols and/or Bluetooth protocols. In embodiments where wired network 110.1 is a chassis management bus, chassis management controller 148 comprises an interface to the chassis management bus. In some embodiments of the invention, chassis management controller 148 supports ICMB communications between BMC 140 and other devices coupled to chassis management bus.

In some embodiments, BMC 140 communicates with devices on baseboard system 120 via a platform management bus 152. In some embodiments, platform management bus 152 connects various components on baseboard system 120 that are able to report their status to BMC 140 over bus 152. In some embodiments, bus 152 is an Intelligent Platform Management Bus (IPMB) available from Intel Corporation.

In alternative embodiments, Fast Data Link 154 is a parallel bus interface interconnecting BMC 140 with various items on baseboard system 120 and provides a fast data link between connected items. In some embodiments, fast data link 154 may be provided in addition to or instead of platform management bus 152. In varying embodiments Fast data link 154 may comprise a 4-bit or 8-bit parallel bus.

BMC 140 may be integrated with baseboard system 120, or it may be an add-on card known as a “daughter card” that may be plugged into baseboard system 120. In operation BMC 140 monitors the health or state of components on baseboard system 120 that are coupled to BMC 140 via platform management bus 152. Upon detecting a fault or other anomalous conditions, BMC 140 generates an alert message. In some embodiments, BMC 140 will send the alert message to a management system through a first communications interface 126. However, if first communications interface is unable to send the message due to a fault or other condition, BMC 140 in some embodiments selects a second communications interface to send the alert message. In some embodiments, the second communications interface may be on baseboard systems 120, for example second communications interface 130. In alternative embodiments of the invention, BMC 140 may send the alert message through a communications interface on BMC 140 such as BMC communications interface 146 or chassis management controller 148.

Messages sent outside of the normal alert message channel by any of second communications interface 130, communications interface 146 or chassis management controller 148 are generally sent to a proxy system 104 (FIG. 1). Proxy system 104 then forwards the message to management system 106 as discussed above.

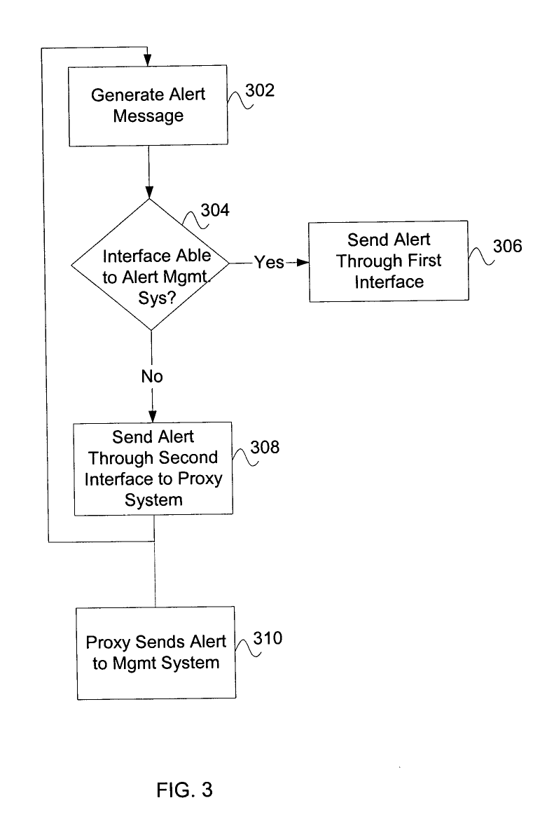

FIG. 3 is a flowchart illustrating methods for sending an alert message from a monitored system to a management system via a proxy system according to embodiments of the invention. The methods may be performed within an operating environment such as that described above with reference to FIGS. 1 and 2. The methods to be performed by the operating environment constitute computer programs made up of computer-executable instructions. Describing the methods by reference to a flowchart enables one skilled in the art to develop such programs including such instructions to carry out the methods on suitable computers (the processor of the computer executing the instructions from computer-readable media such as RAM, ROM, CD-ROM, DVD-ROM, flash memory etc.). The methods illustrated in FIG. 3 are inclusive of the acts performed by an operating environment executing an exemplary embodiment of the invention.

The method begins when a system executing the method determines that an alert message should be generated and sent from the system (block 302). The alert message may be in response to the actual or impending failure of a component on the system, or it may be a status message regarding the system or system components.

Next, the system determines whether the interface designated to send alerts through normal channels is able to do so (block 304). If so, the alert message is sent through a first interface representing the normal channel of communication of alerts (block 306).

However, if the interface configured as the normal channel to send alerts is unable to do so, the system checks for a configured proxy system and sends the alert message through a second communications interface to the designated proxy system (block 308). The method then returns to await a new alert message.

Additionally, the message sent to the proxy system is received by the proxy system and forwarded to the management system by the proxy system acting on the behalf or the system executing the method.

Those of skill in the art will appreciate that the functionality described above may be distributed across hardware and software in various manners. For example, the method may be executed by the baseboard management controller described above in reference to FIG. 2. Additionally method may be executed by the baseboard system itself without the need for a BMC. Further, the method may be executed in whole or in part by a BIOS (Basic Input/Output System) or EFI (Extensible Firmware Interface) on the baseboard system. Still further, the method may be executed in whole or in part by an add-on card such as a wireless network interface card. The embodiments of the invention are not limited to any particular distribution of functionality.

Systems and methods for sending alerts to a proxy system have been described. The embodiments of the invention provide advantages over previous systems. For example, the systems and methods of the various embodiments of the invention provide a means for alerts to be sent to a management system even when there has been a failure in the normal interface for sending alerts. This allows the management system to receive alerts it would not receive in previous systems.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

1. A method comprising:
detecting a fault in a monitored component;
determining that a first communications interface cannot send an alert message regarding the fault; and
sending the alert message regarding the fault through a second communications interface to a proxy system for forwarding to a management system.

2. The method of claim 1, wherein the first communications interface comprises a network interface configured to send alert messages to a management system.

3. The method of claim 1, wherein the second communications interface comprises a network interface configured to send alert messages to a proxy.

4. The method of claim 3 wherein the second communications interface comprises a wireless network interface.

5. The method of claim 4, wherein the wireless network interface substantially conforms to the IEEE 802.11 protocol.

6. The method of claim 3, wherein the second communications interface comprises a wired network interface.

7. The method of claim 3, wherein second communications interface comprises an Intelligent Chassis Management Bus.

8. A device comprising:
a processor;
a memory coupled to the processor;
a first communications interface coupled to the processor and configured to send alert messages to a management system; and
a second communications interface coupled to the processor and configured to send alert messages to a proxy system;
wherein the processor is operable to:
generate an alert message,
determine that the first communications interface is unable to send the alert message, and
send the alert message through the second communications interface to the proxy system.

9. The device of claim 8, first communications interface comprises a network interface.

10. The device of claim 8, wherein the second communications interface comprises a network interface.

11. The device of claim 10 wherein the second communications interface comprises a wireless network interface.

12. The device of claim 11, wherein the wireless network interface substantially conforms to the IEEE 802.11 protocol.

13. The device of claim 8, wherein the second communications interface comprises a wired network interface.

14. The device of claim 8, wherein the second communications interface comprises an Intelligent Chassis Management Bus.

15. A machine-readable media having machine executable instructions for performing a method comprising:
detecting a fault in a monitored component;
determining that a first communications interface cannot send an alert message regarding the fault; and
sending the alert message regarding the fault through a second communications interface to a proxy system for forwarding to a management system.

16. The machine-readable media of claim 15, wherein the first communications interface comprises a network interface configured to send alert messages to a management system.

17. The machine-readable media of claim 15, wherein the second communications interface comprises a network interface configured to send alert messages to a proxy.

18. The machine-readable media of claim 17 wherein the second communications interface comprises a wireless network interface.

19. The machine-readable media of claim 18, wherein the wireless network interface substantially conforms to the IEEE 802.11 protocol.

20. The machine-readable media of claim 17, wherein the second communications interface comprises a wired network interface.

21. The machine-readable media of claim 17, wherein second communications interface comprises an Intelligent Chassis Management Bus.

22. A system comprising
a monitored computer system communicably coupled to a first network and a second network, said monitored system operable to:
detect that an alert message cannot be sent to the management system through the first network and
send the alert message to the proxy system through the second network; and
a proxy system communicably coupled to the first network and the second network and operable to receive the alert message from the monitored system on the second network and to forward the alert message to a management system communicably coupled to the first network.

23. The system of claim 22 wherein the first network comprises a wired network;

24. The system of claim 22 wherein the second network comprises a wireless network.

25. The system of claim 24, wherein the wireless network comprises a Bluetooth network.

26. The system of claim 24, wherein the wireless network substantially conforms to a version of the IEEE 802.11 protocol.

27. The system of claim 22, wherein the second network comprises an Intelligent Chassis Management Bus.
